(19) United States
(12) Patent Application Publication
(10) Pub. No.: US 2026/0093627 A1
(43) Pub. Date: Apr. 2, 2026

(54) DATA STORAGE DEVICE EFFICIENTLY MANAGING META INFORMATION AND OPERATING METHOD THEREOF

(71) Applicant: SK hynix Inc., Icheon-si (KR)

(72) Inventor: Ik Joon SON, Icheon-si (KR)

(21) Appl. No.: 19/045,925

(22) Filed: Feb. 5, 2025

(30) Foreign Application Priority Data
Sep. 27, 2024 (KR) 10-2024-0131821

(51) Int. Cl. G06F 12/0802

(52) U.S. Cl. CPC G06F 12/0802

(57) ABSTRACT

A data storage device may include a memory controller configured to determine a number of meta information entries to be stored in each cache group that includes a plurality of cache lines, selects a meta information entry whose index matches an address of a corresponding cache line, store the selected meta information entry in the corresponding cache line of a normal table including a plurality of cache groups, and store exception entries, which represent meta information entries that are not stored in the normal table, in an exception table including a plurality of cache groups, wherein a size of meta information entry is larger than a size of cache line.

### CROSS-REFERENCES TO RELATED APPLICATION

The present application claims priority under 35 U.S.C. § 119(e) to Korean Patent Application Number 10-2024-0131821, filed on Sep. 27, 2024, in the Korean Intellectual Property Office, which is incorporated herein by reference in its entirety.

### BACKGROUND

### 1. Technical Field

The present technology relates to a data storage device, and more particularly, to a data storage device that efficiently manages meta data and an operating method of the data storage device.

### 2. Related Art

A data storage device may store data in a memory device or read data stored in the memory device and provide the data to an external device upon a request from the external device.

A logical address, which is an address used by the external device, may be different from a physical address, which is an address used by the memory device. Therefore, the data storage device may perform address translation, for example, address mapping, between the logical address and the physical address.

Meta information, including mapping information between a logical address and a physical address, may include a plurality of entries. The meta information may be stored in a memory device and at least partially loaded into a buffer memory device to process a request from an external device.

As the capacity of a memory device increases, the size of the meta information also increases.

A method for efficiently arranging entries of the meta information in the buffer memory device is required to enable high-speed searching of the entries of the meta information loaded into the buffer memory device.

### SUMMARY

A data storage device according to an embodiment of the present technology may include: a memory device; a buffer memory device including a plurality of cache lines, each assigned an address; and a memory controller configured to store meta information related to data stored in the memory device in the cache lines and read the meta information from the buffer memory device to control the memory device. The meta information includes multiple meta information entries, and the memory controller determines a number of meta information entries to be stored in each cache group that includes a plurality of cache lines, wherein the memory controller selects a meta information entry whose index matches an address of a corresponding cache line, stores the selected meta information entry in the corresponding cache line of a normal table including a plurality of cache groups, and stores exception entries, which represent meta information entries that are not stored in the normal table, in an exception table including a plurality of cache groups, wherein a size of meta information entry is larger than a size of cache line.

An operating method of a data storage device that includes a memory device and a memory controller configured to control the memory device based on meta information including multiple meta information entries stored in a buffer memory device that includes a plurality of cache lines, each assigned an address, according to an embodiment of the present technology may include: grouping, by the memory controller, the plurality of the cache lines to form a plurality of cache groups; determining, by the memory controller, a number of meta information entries to be stored in each cache group; selecting, by the memory controller, a meta information entry whose index matches an address of a corresponding cache line, and storing the selected meta information entry in the corresponding cache line of a normal table including a plurality of cache groups; and storing, by the memory controller, exception entries, which represent meta information entries that are not stored in the normal table, in an exception table including a plurality of cache groups, wherein a size of meta information entry is configured to be larger than a size of cache line.

### BRIEF DESCRIPTION OF THE DRAWINGS

FIG. 1 is a block diagram illustrating a data processing system according to an embodiment of the present technology.

FIG. 2 is a diagram illustrating mapping information according to an embodiment of the present technology.

FIG. 3 is a diagram illustrating a concept of storing meta information having a size smaller than or equal to a size of a cache line in a buffer memory device.

FIG. 4 is a diagram illustrating a concept of storing meta information having a size larger than a size of a cache line in a buffer memory device.

FIG. 5 is a block diagram illustrating a meta information manager according to an embodiment of the present technology.

FIG. 6 is a block diagram illustrating a concept of storing meta information according to an embodiment of the present technology.

FIG. 7 is a flowchart illustrating an operating method of a data storage device according to an embodiment of the present technology.

FIG. 8 is a flowchart illustrating an operating method of a data storage device according to an embodiment of the present technology.

FIG. 9 is a diagram illustrating a concept of storing meta information having a size larger than a size of a cache line in a buffer memory device, according to an embodiment of the present technology.

### DETAILED DESCRIPTION

Various embodiments of the present technology are directed to a data storage device that may efficiently manage meta information by matching a cache line address of a buffer memory device with an index of a meta information entry and storing the meta information entry.

According to embodiments of the present technology, a meta information entry may be searched at high speed in a buffer memory device.

Hereinafter, embodiments of the present technology will be described in more detail with reference to the accompanying drawings.

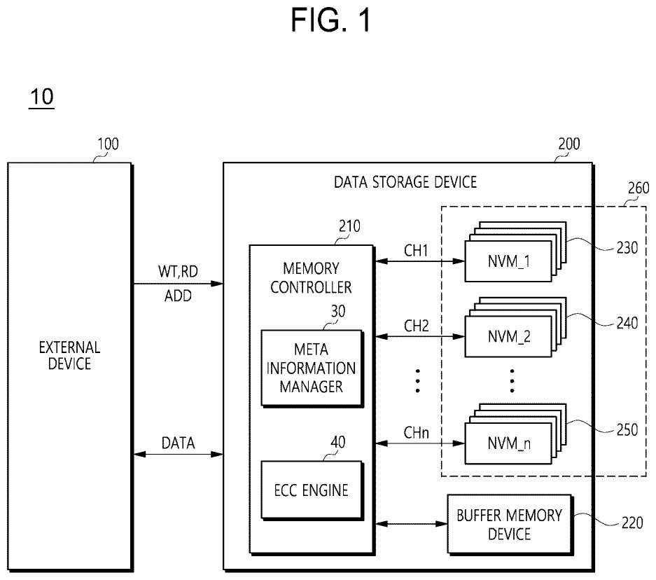

FIG. 1 is a block diagram illustrating a data processing system 10 according to an embodiment of the present technology.

Referring to FIG. 1, the data processing system 10 may include an external device 100 and a data storage device 200.

The external device 100 may include at least one processor. The external device 100 may be a processor itself, or an electronic device or system including a processor.

The data storage device 200 may include a memory controller 210, a buffer memory device 220, and a memory device 260. The memory device 260 may include at least a plurality of non-volatile memory devices, e.g., 230, 240, and 250.

The external device 100 may transmit a write request including a write command WT, an address ADD, and write data DATA to the data storage device 200. In response to the write request, the memory controller 210 may control the memory device 260 to program the write data DATA.

The external device 100 may transmit a read request including a read command RD and an address ADD to the data storage device 200. The memory controller 210 may control the memory device 260 to read data DATA, which is requested to be read, from the memory device 260 and transmit the read data DATA to the external device 100.

The data storage device 200 may read data from the memory device 260 or write data to the memory device 260, performing not only operations in response to the read and write requests from the external device 100 but also internal operations independently. The internal operations may include a housekeeping operation performed independently of requests from the external device 100, such as garbage collection, wear leveling, and read reclaim operations. These operations help efficiently use the storage space of the memory device 260 and ensure reliability of data stored in the memory device 260.

The buffer memory device 220 may temporarily store data transmitted and received between the external device 100 and the data storage device 200 or between the memory controller 210 and the memory device 260, during a write or read operation.

The memory controller 210 interfaces between the external device 100 and the data storage device 200.

The memory controller 210 may include a meta information manager 30 and an error correction code (ECC) engine 40.

The meta information manager 30 may manage meta information, such as mapping information, required to perform the operations in response to the requests from external devices 100 and the internal operations of the data storage device 200. The meta information may include a plurality of meta information entries, and a unique index may be assigned to each of the meta information entries. In an embodiment, when the meta information is the mapping information, the index of the mapping information entry may be a logical address, but the present technology is not limited thereto.

The meta information may be stored in the memory device 260 and loaded into the buffer memory device 220 to be used and updated during the operations of the data storage device 200.

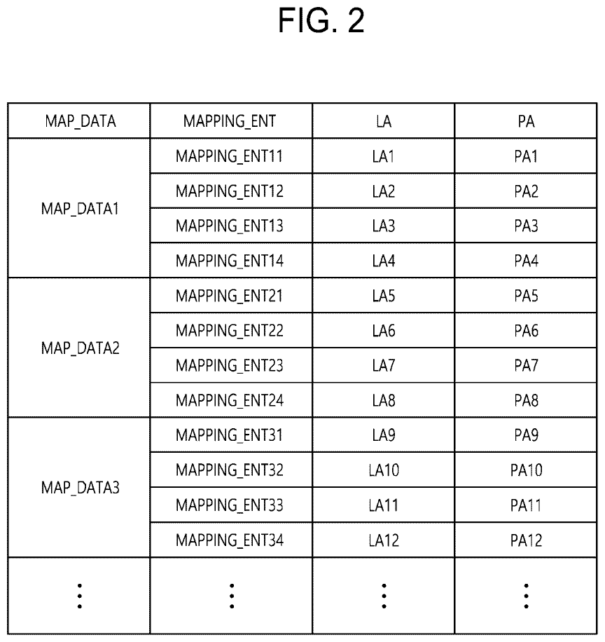

FIG. 2 is a diagram illustrating mapping information according to an embodiment of the present technology.

Referring to FIG. 2, meta information may include mapping information, e.g., MAP_DATA1, MAP_DATA2, and MAP_DATA3. Each of the mapping information MAP_DATA1, MAP_DATA2, and MAP_DATA3 may include a plurality of mapping information entries MAPPING_ENTxi, each representing a mapping relationship between a logical address LA and a physical address PA. For example, in FIG. 2, x represents a natural number.

In an embodiment, the meta information may be generated by a flash translation layer (FTL) of the memory controller 210.

Referring back to FIG. 1, the ECC engine 40 may detect and correct errors in data, for example, write data, read data, and meta information, accessed by the memory controller 210. The ECC engine 40 may perform error detection and correction in a predetermined unit of ECC processing.

In an embodiment, the buffer memory device 220 may include a plurality of cache lines, each having a predetermined size, and a unique address may be assigned to each of the cache lines. The unit of ECC processing of the ECC engine 40 may be determined by 2N cache lines, where “N” is a natural number greater than or equal to 3 and less than or equal to “Q.” The unit of ECC processing may be a value that is predetermined when the ECC engine 40 is manufactured or when the data storage device 200 is manufactured. “Q” is a predetermined value.

The meta information manager 30 may store meta information entries, each having a size larger than a size of each of the cache lines, in the buffer memory device 220.

To store the meta information entries, each having the size larger than the size of each of the cache lines, in the buffer memory device 220, the meta information manager 30 may group a predetermined quantity (or number) of cache lines of the buffer memory device 220, such as those corresponding to the unit of ECC processing, and form cache groups. In other words, each of the cache groups may include a number of cache lines corresponding to the unit of ECC processing.

The meta information manager 30 may determine a number of meta information entries for each group to be stored in each of the cache groups, based on the size of cache group (the size of cache line*the number of cache lines for each cache group) and the size of meta information entry.

The meta information manager 30 may store meta information entries, each having the same index as an address of a cache line of a cache group, in a normal table and store exception entries, which are meta information entries not stored in the normal table, in an exception table. The exception table may be configured with “K” exception tables, where “K” is a natural number greater than or equal to 1.

Addresses with a leading address set to “0” may be sequentially assigned to the cache lines constituting the normal table and the exception table. In other words, the addresses assigned to the cache lines of the normal table and the exception table may be in a continuous sequence.

The meta information manager 30 may store a meta information entry, among the exception entries not stored in the normal table, in a K^{th} exception table if the least significant K*N bits of the meta information entry are all set to 1.

An address may be assigned to each of the cache lines constituting the exception table, and an exception entry may be stored in the K^{th} exception table if the remainder obtained by dividing an index of the exception entry by (2^{N})^{K} is (2^{N})^{K}−1.

Specific configurations for selecting the meta information entries to be stored in the normal table and the exception table are described later.

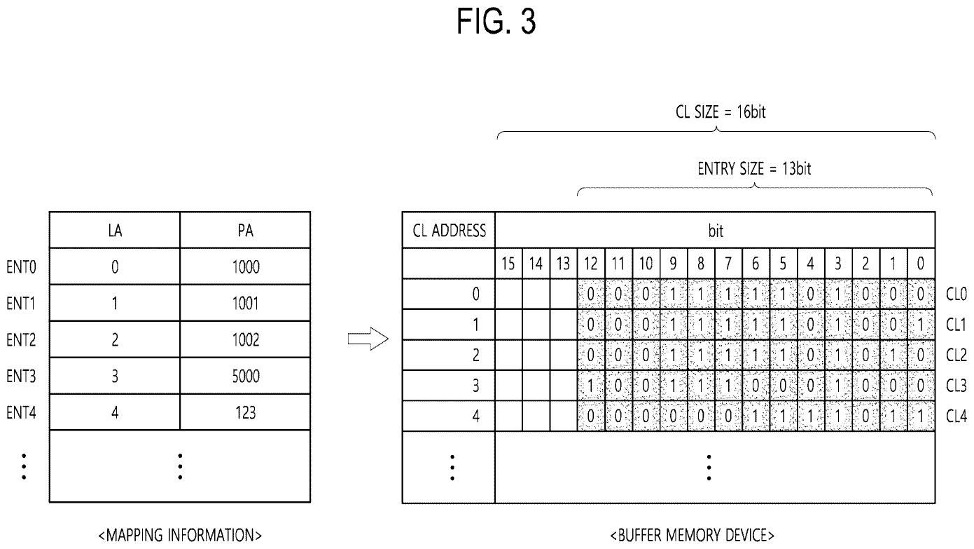

FIG. 3 is a diagram illustrating a concept of storing meta information having a size smaller than or equal to a size of a cache line in a buffer memory device.

Referring to FIG. 3, unique addresses 0, 1, 2, 3, and 4 may be assigned to cache lines CL0, CL1, CL2, CL3, and CL4 of the buffer memory device, respectively, and the size of each of the cache lines CL0, CL1, CL2, CL3, and CL4 may be 16 bits.

Mapping information, which is one type of meta information, may include a plurality of entries, e.g., ENT0, ENT1, ENT2, ENT3, and ENT4 that indicate physical addresses PA corresponding to logical addresses LA. The size of each of the entries ENT0, ENT1, ENT2, ENT3, and ENT4 may be 13 bits. The logical addresses LA may indicate indexes of the corresponding entries ENT0, ENT1, ENT2, ENT3, and ENT4.

Because the size (13 bits) of each of the entries ENT0, ENT1, ENT2, ENT3, and ENT4 is smaller than the size (16 bits) of each of the cache lines CL0, CL1, CL2, CL3, and CL4, one entry ENT0, ENT1, ENT2, ENT3, or ENT4 may be stored in each of the cache lines CL0, CL1, CL2, CL3, and CL4. In addition, the indexes 0, 1, 2, 3, and 4 of the entries ENT0, ENT1, ENT2, ENT3, and ENT4 may be aligned to match the addresses 0, 1, 2, 3, and 4 of the cache lines CL0, CL1, CL2, CL3, and CL4, respectively.

Therefore, mapping information for any logical address LA may be efficiently searched within the buffer memory device.

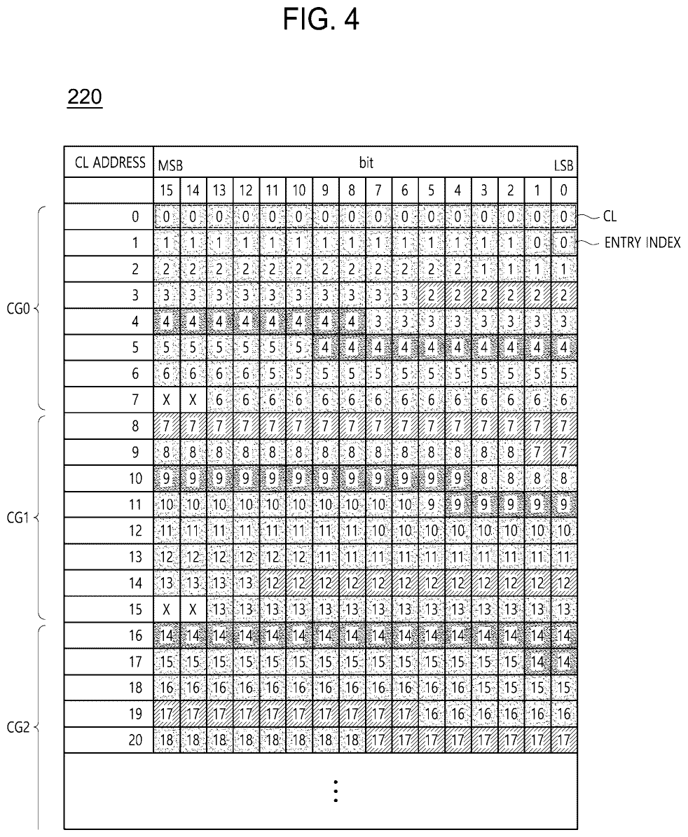

FIG. 4 is a diagram illustrating a concept of storing meta information having a size larger than a size of a cache line in a buffer memory device.

As a data storage capacity of the memory device 260 increases, the size of a mapping information entry, which is one type of meta information, also increases. Consequently, the size of the mapping information entry may be larger than the size of the cache line.

FIG. 4 illustrates an example where a mapping information entry of 18 bits is stored in cache lines CL, each having a size of 16 bits. Each cache line is assigned a unique address ranging from 0 to 20. Each number in the cache lines CL represents an index of a mapping information entry.

The meta information manager 30 may group the buffer memory device 220 in a unit of ECC processing and form a plurality of cache groups, e.g., CG0, CG1, and CG2. To ensure the detection and correction of errors in mapping information, each mapping information entry may be stored within a single cache group, rather than being distributed across the plurality of cache groups.

When the processing unit of the ECC engine 40 corresponds to 2^{N} (where “N” is 3) cache lines, data is not stored in the most significant 2 bits of an 8^{th} cache line (CL=7) and the most significant 2 bits of a 16^{th} cache line (CL=15). This ensures that one mapping information entry is entirely stored in a single cache group.

Because the size (18 bits) of the mapping information entry is larger than the size (16 bits) of the cache line, one mapping information entry may be distributed across two cache lines. Accordingly, the index of the mapping information entry and the address of the cache line do not align. This misalignment necessitates an additional operation to calculate the address of the cache line where the mapping information entry is stored, which can lead to a decline in the performance of the data storage device 200.

Referring to FIG. 4, the entry index and the address of the cache line are misaligned. For example, the mapping information entry with the entry index of “7” is stored in the cache line with the address of “8.”

For example, to search for the mapping information with the index of “17” in the buffer memory device 220, operations that are computationally slow, such as a division operation and a remainder operation, are involved. The calculation would be: floor (index/[a number of entries in a cache group])*[a number of cache lines in a cache group]+index % [a number of entries in a cache group]=19.

Because hundreds of millions to hundreds of billions of mapping information entries may be stored in the buffer memory device 220, the latency for processing a request from the external device 100 may increase due to the computational burden of such operations.

Therefore, the meta information manager 30 according to the present technology may arrange the meta information in the buffer memory device 220 so that the index of the meta information entry, such as the mapping information, and the address of the cache line coincide. This arrangement ensures the required performance of the data storage device 200.

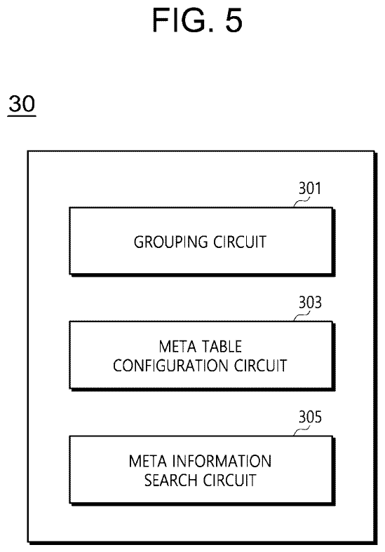

FIG. 5 is a block diagram illustrating the meta information manager 30 according to an embodiment of the present technology.

Referring to FIG. 5, the meta information manager 30 may include a grouping circuit 301, a meta table configuration circuit 303, and a meta information search circuit 305.

The grouping circuit 301 may group a predetermined number of cache lines constituting the buffer memory device 220, for example, a unit 2^{N} of ECC processing, and form a plurality of cache groups. The size of each of the cache groups may be determined by multiplying the number of cache lines in the cache group by the size of each cache line.

The grouping circuit 301 may determine a number of meta information entries to be stored in one cache group, based on the size of each cache group and the size of each meta information entry.

For example, when one cache line is 31 bits and the unit of ECC processing is 16 (2^{N}, where “N” is 4) cache lines, the size of the cache group may be 31*16=496 bits. When the size of the meta information entry is 33 bits, a number of entries that can be stored in one cache group may be determined as floor (496/33)=15.

A number of cache lines in a cache group and the size of each of the cache lines may be obtained from configuration information of the buffer memory device 220. The unit of ECC processing and the size of each of the meta information entries may be predetermined when the data storage device 200 is manufactured and may vary depending on the specific usage environments.

The meta table configuration circuit 303 may configure a plurality of tables in which meta information entries are to be stored, based on the indexes LA of the meta information entries, the unit 2^{N} of ECC processing, and a number E of meta information entries to be stored in each of the cache groups.

The meta table configuration circuit 303 may configure a normal table for storing meta information entries that have the same indexes as addresses of the cache lines in the cache groups. In an embodiment, the meta table configuration circuit 303 may store a meta information entry in the normal table if the remainder obtained by dividing each index LA by 2^{N} (mod (LA, 2^{N})) is less than the number E of entries that can be stored in each of the cache groups.

In this case, a meta information entry whose index is 2^{N}*M−1 (where “M” is a cache group number in the normal table, and “M” is a natural number greater than or equal to 1) may be selected as an exception entry. This is because the meta information entry is stored across a plurality of cache groups, exceeding the unit of ECC processing, when stored in a cache line whose address is 2^{N}*M−1 in an M^{th} cache group.

In an embodiment, the meta table configuration circuit 303 may configure at least one exception table for storing exception entries that are not stored in the normal table. The exception table may be configured with “K” exception tables, where “K” is a natural number greater than or equal to 1.

The meta table configuration circuit 303 may store meta information entries, among the exception entries, whose least significant K*N bits are all set to 1 in a K^{th} exception table.

An address may be assigned to each of the cache lines that constitute the exception table. The meta table configuration circuit 303 may configure the meta table so that an exception entry, whose remainder mod (LA, (2^{N})^{K}) obtained by dividing the index of the exception entry by (2^{N})^{K} is (2^{N})^{K}−1, is stored in the K^{th} exception table.

The meta table configuration circuit 303 may arrange the exception entry so that a value obtained by dividing the index of the exception entry by (2^{N})^{K} coincides with the address of the cache line constituting the exception table, thus ensuring the exception entry is stored in the K^{th} exception table. Because dividing a number by (2^{N})^{K} is equivalent to performing a K*N bit right shift operation, this approach ensures a fast operation speed.

The meta information search circuit 305 may search for the meta table in the buffer memory device 220 using the logical address LA as an index when an address search is requested.

In an embodiment, the meta information search circuit 305 may search for the meta information entries in the normal table when the remainder (mod, LA (2^{N})) obtained by dividing the index, which is the logical address LA to be searched, by 2^{N} is less than the number E of entries that can be stored in the cache group.

In an embodiment, the meta information search circuit 305 may search for the meta information entries in the K^{th} exception table when the remainder mod (LA, (2^{N})^{K}) obtained by dividing the index, which is the logical address LA to be searched, by (2^{N})^{K} is (2^{N})^{K}−1.

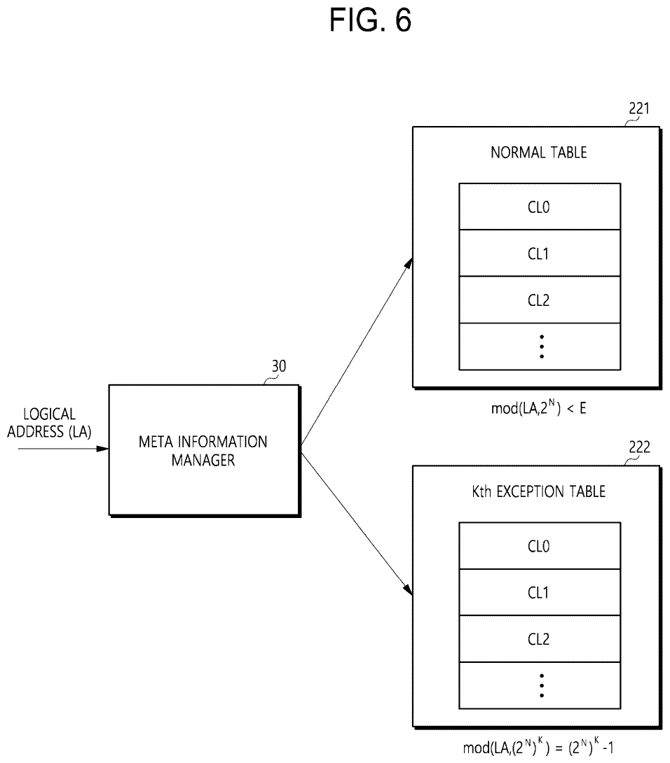

FIG. 6 is a block diagram illustrating a concept of storing meta information according to an embodiment of the present technology.

Referring to FIG. 6, the meta information manager 30 may constitute or search for a meta table as a logical address LA is provided. The meta table may include a normal table 221 and an exception table 222.

The meta information manager 30 may store or search for a meta information entry whose remainder mod (LA, 2^{N}) obtained by dividing the logical address LA, which serves as an index, by 2^{N} is less than a number of entries E included in a cache group in the normal table 221.

The meta information manager 30 may store or search for a meta information entry whose remainder mod (LA, (2^{N})^{K}) obtained by dividing the logical address LA, which serves as an index, by (2^{N})^{K} is (2^{N})^{K}−1 in a K^{th} exception table 222.

In the exception table 222, each exception entry is stored in a cache line having an address corresponding to a value obtained by shifting the logical address LA, which serves as an index of the exception entry, to the right by K*N bits. This arrangement ensures that the address of the cache line and the index of the meta information entry may coincide in the exception table 222.

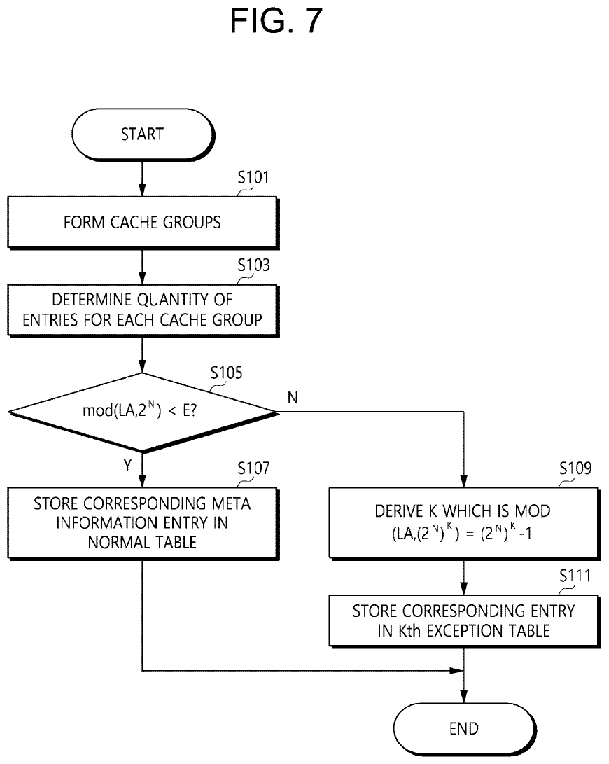

FIG. 7 is a flowchart illustrating an operating method of the data storage device 200 according to an embodiment of the present technology.

The memory controller 210 including the meta information manager 30 may group a predetermined number of cache lines that constitutes the buffer memory device 220, for example, by the unit 2^{N} of ECC processing, to form a plurality of cache groups in step S101. The size of each of the cache groups may be calculated as the product of the number of cache lines in each cache group and the size of each cache line.

The memory controller 210 may determine a number of meta information entries to be stored in one cache group, based on the size of each of the cache groups and the size of each of the meta information entries, in step S103.

For example, when the size of one cache line is L bits and the unit of ECC processing is 2^{N} cache lines, the size of the cache group may be L*2^{N} bits. When the size of the meta information entry is Y bits, the number of entries E that can be stored in one cache group may be determined as floor (L*2^{N}/Y).

The number of cache lines included in the buffer memory device 220 and a size L of each of the cache lines may be obtained from configuration information of the buffer memory device 220. The unit 2^{N} of ECC processing and the size Y of the meta information entry may be predetermined when the data storage device 200 is manufactured and may vary depending on the specific usage environments.

To store the meta information entries in the buffer memory device 220, the memory controller 210 may configure a plurality of tables in which the meta information entries are to be stored, based on the indexes LA of the meta information entries, the unit 2^{N} of ECC processing, and the number E of the meta information entries to be stored in the cache group.

The memory controller 210 may configure a normal table for storing the meta information entries that have the same index as the addresses of cache lines in the cache group. In an embodiment, the memory controller 210 may check whether the remainder mod (LA, 2^{N}) obtained by dividing the index, which is the logical address LA of the meta information, by 2^{N} is less than the number E of entries that can be stored in the cache group, in step S105.

When the remainder mod (LA, 2^{N}) is less than the number E of entries in the cache group (that is, “Y” in step S105), the memory controller 210 may store the corresponding meta information entry in the normal table in step S107.

On the other hand, when the remainder mod (LA, 2^{N}) is not less than the number E of entries in the cache group (that is, “N” in step S105), the memory controller 210 may derive a K value that the remainder mod (LA, (2^{N})^{K}) obtained by dividing the index by (2^{N})^{K} satisfies (2^{N})^{K}−1, in step S109, and store the corresponding entry in the K^{th} exception table in step S111.

From another perspective, the memory controller 210 may store, in the K^{th} exception table, meta information entries whose least significant K*N bits are all set to 1, among the exception entries that are not stored in the normal table.

To store the exception entries in the K^{th} exception table, the memory controller 210 may arrange the exception entries so that the value obtained by dividing the index of each of the exception entries by (2^{N})^{K}, that is, the value shifted to the right by K*N bits, coincides with the address of each of the cache lines constituting the exception table.

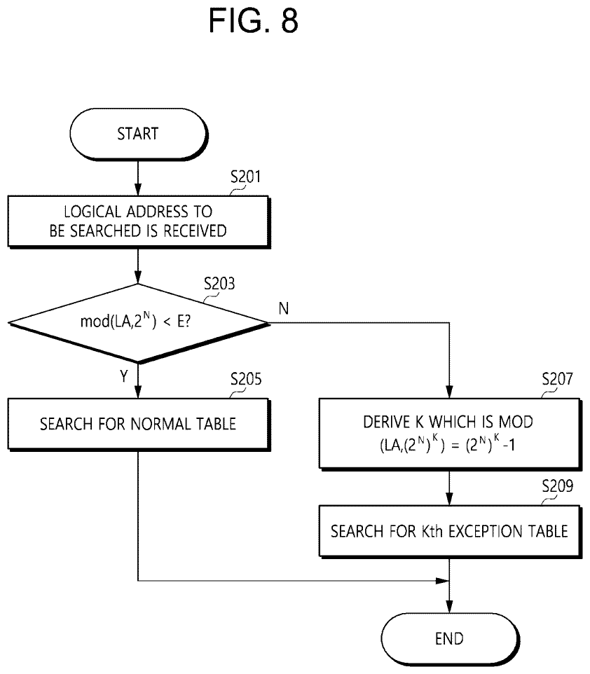

FIG. 8 is a flowchart illustrating an operating method of the data storage device 200, according to an embodiment of the present technology.

When a logical address LA is received in step S201, the memory controller 210 may check whether the remainder mod (LA, 2^{N}) obtained by dividing the index, which is the logical address LA, by 2^{N} is less than the number E of entries in the cache group, in step S203.

When the remainder mod (LA, 2^{N}) is less than the number E of entries in the cache group (that is, “Y” in step S203), the memory controller 210 may search for a meta information entry in the normal table in step S205.

On the other hand, when the remainder mod (LA, 2^{N}) is not less than the number E of entries in the cache group (that is, “N” in step S203), the memory controller 210 may derive a K value such that the remainder mod (LA, (2^{N})^{K}) satisfies (2^{N})^{K}−1, in step S207. After that, the memory controller 210 may search for the corresponding meta information entry in the K^{th} exception table in step S209.

In this case, when the cache line, which has the address corresponding to the value obtained by dividing the index of the exception entry in the K^{th} exception table by (2^{N})^{K}, that is, the value shifted to the right by K*N bits, is accessed, the value corresponding to the corresponding meta information entry may be read.

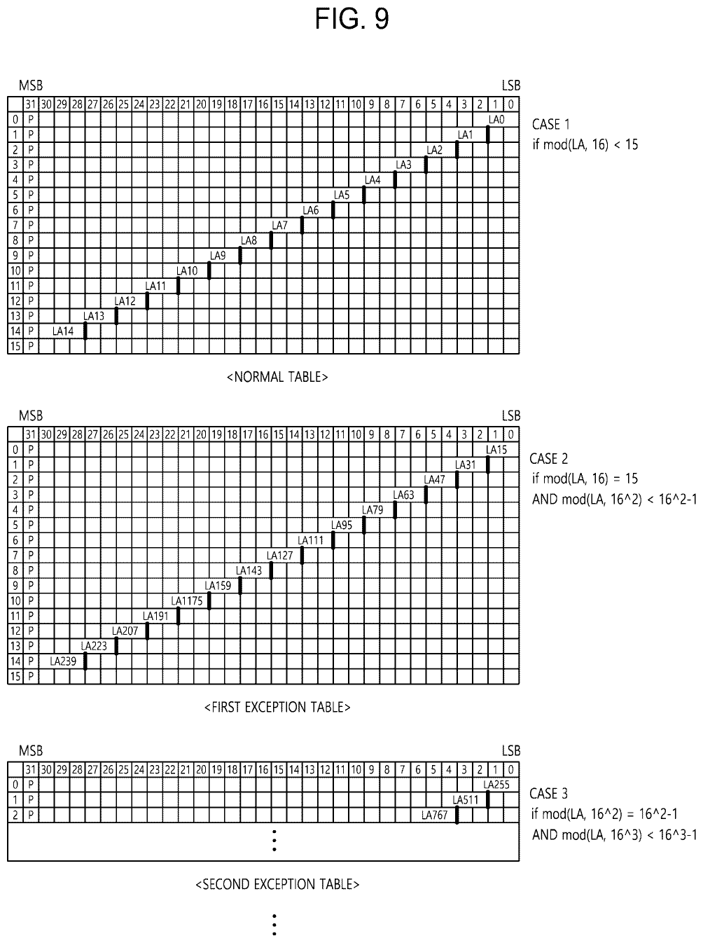

FIG. 9 is a diagram illustrating a concept of storing meta information having a size larger than a size of a cache line in a buffer memory device, according to an embodiment of the present technology.

Referring to FIG. 9, when the size L of the cache line is 31 bits and the unit of ECC processing is 16 (2^{N}, N=4) cache lines, the size of the cache group may be 31*16=496. When the size Y of the meta information entry is 33 bits, the number of entries that can be stored in one cache group may be determined as floor (496/33)=15. Parity data P may be stored in the most significant bit (MSB) of the cache line.

To configure the normal table, the memory controller 210 may select a meta information entry whose remainder mod (LA, 2^{N}) obtained by dividing the logical address LA, which serves as the index of the meta information entry, by 2^{N} is less than the number E of entries E that can be stored in the cache group.

To configure a first exception table, the memory controller 210 may select an exception entry whose remainder mod (LA, (2^{N})^{K}) obtained by dividing the index by (2^{N})^{K} (K=1) satisfies (2^{N})^{K}−1. Accordingly, an exception entry whose remainder obtained by dividing the logical address LA by 16 (=2^{N}) equals E (=15) and whose remainder mod (LA, 16²) obtained by dividing the index by 16² is less than 16²−1 may be stored in the first exception table.

To configure a second exception table, the memory controller 210 may select an exception entry whose remainder mod (LA, (2^{N})^{K}) obtained by dividing the index by (2^{N})^{K} (K=2) satisfies (2^{N})^{K}−1. Accordingly, an exception entry whose remainder obtained by dividing the logical address LA by 16² equals 16²−1 and whose remainder mod (LA, 16³) obtained by dividing the index by 16³ is less than 16³−1 may be stored in the second exception table.

In the same way, the normal table and a plurality of exception tables may be configured for each meta information entry. In addition, when a meta information entry is required to be searched, the appropriate table containing the logical address LA for which a search is requested may be identified and accessed, allowing the meta information entry to be retrieved.

For example, when a search for a meta information entry corresponding to a logical address LA 12 is requested, the memory controller 210 may access a cache line whose address is 12 in the normal table because mod (12, 16)=12<15 and read the meta information entry corresponding to the logical address 12.

When a search for a meta information entry corresponding to logical address LA 191 is requested, the memory controller 210 may determine that the meta information entry corresponding to the logical address 191 is stored in the first exception table. This determination is based on the condition that the K value satisfying mod (191, 16^{K})=16^{K}−1 is 1. Because the quotient of 191 (binary 10111111) divided by 16 (equivalent to a right shift by 4 bits) is 11, the memory controller 210 may access a cache line at address 11 in the first exception table to read the meta information entry corresponding to the logical address 191.

Even if the size of a meta information entry is larger than the size of a cache line, high-speed searches can still be performed. This is because the meta information entry, such as mapping information, is stored in the cache line at the address corresponding to an index of the entry.

Although an exemplary embodiment of the present technology has been described for illustrative purposes, those skilled in the art will appreciate that various modifications and changes are possible, without departing from the essential features of the technology. Accordingly, the exemplary embodiments disclosed in the present technology are not intended to limit but illustrate the technical spirit of the present technology, and the scope of the technical spirit of the present technology is not limited by the exemplary embodiments. The protection scope of the present technology should be construed based on the following appended claims and it should be interpreted that all the technical spirit included within the scope identical or equivalent to the claims belongs to the scope of the present technology.

What is claimed is:

1. A data storage device comprising:
a memory device;
a buffer memory device including a plurality of cache lines, each assigned an address; and
a memory controller configured to store meta information related to data stored in the memory device in the cache lines and read the meta information from the buffer memory device to control the memory device,
wherein the meta information includes multiple meta information entries, and the memory controller determines a number of meta information entries to be stored in each cache group that includes a plurality of cache lines,
wherein the memory controller selects a meta information entry whose index matches an address of a corresponding cache line, stores the selected meta information entry in the corresponding cache line of a normal table including a plurality of cache groups, and stores exception entries, which represent meta information entries that are not stored in the normal table, in an exception table including a plurality of cache groups, wherein a size of meta information entry is larger than a size of cache line.

2. The data storage device according to claim 1, wherein the normal table includes a plurality of cache lines with continuous addresses, and
the memory controller is configured to store the selected meta information entry in the corresponding cache line whose address matches an index of the selected meta information entry.

3. The data storage device according to claim 1, wherein the meta information includes mapping information between a logical address used by an external device and a physical address assigned to the memory device, and the logical address of the mapping information corresponds to the index.

4. The data storage device according to claim 1, wherein the memory controller is configured to determine the number of meta information entries to be stored in each cache group based on the size of cache line, a number of cache lines included in each of the cache groups, and the size of meta information entry.

5. The data storage device according to claim 1, further comprising an ECC engine configured to perform error detection and correction on data stored in the buffer memory device,
wherein a number of cache lines included in each of the cache groups corresponds to a unit of ECC processing of the ECC engine.

6. The data storage device according to claim 1, wherein the normal table includes a plurality of cache lines with continuous addresses, and a number of cache lines of each of the cache groups is 2^{N}, and
wherein the memory controller is configured to store, in the normal table, a meta information entry whose remainder obtained by dividing its index by 2^{N} is less than the number of meta information entries to be stored in each cache group.

7. The data storage device according to claim 1, wherein the exception table includes a plurality of cache lines with continuous addresses, and a number of cache lines of each of the cache groups is 2^{N}, and
wherein the memory controller is configured to store, in a K^{th} exception table, a meta information entry whose least significant K*N bits of indexes of the exception entries are all set to 1 (where “K” is a natural number greater than or equal to 1 and less than or equal to Q, and “Q” is a predetermined value).

8. The data storage device according to claim 1, wherein the exception table includes a plurality of cache lines with continuous addresses, and a number of cache lines of each of the cache groups is 2^{N}, and
wherein the memory controller is configured to store, in a K^{th} exception table, a meta information entry whose remainder obtained by dividing an index of each of the exception entries by (2^{N})^{K} is (2^{N})^{K}−1 (where “K” is a natural number greater than or equal to 1 and less than or equal to Q, and “Q” is a predetermined value).

9. The data storage device according to claim 8, wherein the memory controller is configured to store an exception entry in a cache line having an address corresponding to a value obtained by shifting an index of the exception entry to the right by N bits.

10. An operating method of a data storage device that includes a memory device and a memory controller configured to control the memory device based on meta information including multiple meta information entries stored in a buffer memory device that includes a plurality of cache lines, each assigned an address, the operating method comprising:
grouping, by the memory controller, the plurality of the cache lines to form a plurality of cache groups;
determining, by the memory controller, a number of meta information entries to be stored in each cache group;
selecting, by the memory controller, a meta information entry whose index matches an address of a corresponding cache line, and storing the selected meta information entry in the corresponding cache line of a normal table including a plurality of cache groups; and
storing, by the memory controller, exception entries, which represent meta information entries that are not stored in the normal table, in an exception table including a plurality of cache groups,
wherein a size of meta information entry is configured to be larger than a size of cache line.

11. The operating method according to claim 10, wherein the normal table includes a plurality of cache lines with continuous addresses, and
the storing of the selected meta information entry in the normal table includes storing the meta information entry in the corresponding cache line whose address matches an index of the selected meta information entry.

12. The operating method according to claim 10, wherein meta information includes mapping information between a logical address used by an external device and a physical address assigned to the memory device, and the logical address of the mapping information corresponds to the index.

13. The operating method according to claim 10, wherein the number of meta information entries to be stored in each cache group is determined based on the size of cache line, a number of cache lines included in each of the cache groups and the size of meta information entry.

14. The operating method according to claim 10, wherein the data storage device further includes an ECC engine configured to perform error detection and correction on data stored in the buffer memory device,
wherein a number of cache lines included in each of the cache groups corresponds to a unit of ECC processing of the ECC engine.

15. The operating method according to claim 10, wherein the normal table includes a plurality of cache lines with continuous addresses, and a number of cache lines of each of the cache groups is 2^{N}, and
wherein the storing of the selected meta information entry in the normal table includes storing, in the normal table, a meta information entry whose remainder obtained by dividing its index by 2^{N} is less than the number of meta information entries to be stored in each cache group.

16. The operating method according to claim 10, wherein the exception table includes a plurality of cache lines with continuous addresses, and a number of cache lines of each of the cache groups is 2^{N}, and
wherein the storing of the exception entries in the exception table includes storing, in a K^{th} exception table, a meta information entry whose least significant K*N bits of indexes of the exception entries are all set to 1 (where “K” is a natural number greater than or equal to 1 and less than or equal to Q, and “Q” is a predetermined value).

17. The operating method according to claim 10, wherein the exception table includes a plurality of cache lines with continuous addresses, and a number of cache lines of each of the cache groups is 2^{N}, and
wherein the storing of the exception entries in the exception table includes storing, in a K^{th} exception table, a meta information entry whose remainder obtained by dividing an indexes of the exception entries by (2^{N})^{K} is (2^{N})^{K}−1 (where “K” is a natural number greater than or equal to 1 and less than or equal to Q, and “Q” is a predetermined value).

18. The operating method according to claim 17, wherein the storing of the exception entries in the exception table includes storing, by the memory controller, the exception entry in a cache line having an address corresponding to a value obtained by shifting an index of the exception entry to the right by N bits.
